(19) United States
(12) Patent Application Publication
(10) Pub. No.: US 2021/0335147 A1
(43) Pub. Date: Oct. 28, 2021

(54) System and User Interfaces for Monitoring Reading Performance and Providing Reading Assistance

(71) Applicant: Rally Reader, LLC, Palo Alto, CA (US)

(72) Inventors: Andrea Johnson, Atherton, CA (US); Matthew Johnson, Atherton, CA (US)

(21) Appl. No.: 16/859,686

(22) Filed: Apr. 27, 2020

(51) Int. Cl. G09B 17/00; G10L 15/26; G09B 17/04; G09B 5/12

(52) U.S. Cl. CPC G09B 17/003; G09B 5/12; G09B 17/04; G10L 15/265

(57) ABSTRACT

A system and user interfaces for monitoring reading performance and providing reading assistance is presented. The user interface for a reader application comprises a user identifier uniquely identifying a user, a listing of a group of monitored reading performance metrics for the uniquely identified user, and a user-selectable list of one or more reading assistance processes. Selecting an item from the list launches the respective reading assistance process.

### FIELD OF INVENTION

Embodiments of the present disclosure pertain to user interfaces for administering and operating a reader application for one or more users. In particular, but not by way of limitation, the present technology provides a user-interface that includes monitored reading performance metrics and provides processes for reading assistance.

### BACKGROUND

Reading provides a fundamental mode of communication and learning, however, a significant number of people struggle with learning how to read. An inability to properly read words may be frustrating, stressful, and may further reduce reading confidence leading to later learning difficulties. Instructing students to read has typically been performed in a classroom environment where, for example, an entire class would read a passage from a text. For example, a teacher may select one student in a group to read a passage and the teacher would evaluate the student during the reading. The teacher would then select another student to read a different passage, and continue the exercise for all students in the class. Recently, electronic books (e-books) have provided convenient paperless access to reading materials such as books. This electronic medium permits customization of the format and presentation of the reading material that is not possible with a paper format. The electronic medium also permits customization of the user interface in which the reading material is presented. These customizations can extend to designs that enhance teaching effectiveness for particular groups of students.

### SUMMARY

According to various embodiments, the present technology is directed to a user interface for administering a reader application comprising electronic speech recognition. The user interface presented on a computer display includes a user identifier tag uniquely identifying a user of the reader application. Also included is a listing of a plurality of monitored reading performance metrics connected with the user identifier tag, and a user-selectable list of at least one reading assistance process connected with the user identifier tag. Selecting an item from the list launches the respective reading assistance process that includes at least one instruction to administer the reading assistance process.

According to some embodiments, the present technology is also directed to a user interface for a reader application comprising electronic speech recognition. The user interface presented on a computer display includes a user identifier tag uniquely identifying a user of the reader application, the tag being presented in a first portion of the user interface. Also included is a listing of a plurality of monitored reading performance metrics for the user identifier tag, the metrics being presented in a second portion of the user interface. In addition, the user interface includes a user-selectable list of at least one reading assistance process, the list being presented in a third portion of the user interface, wherein selecting an item from the list launches the respective reading assistance process.

In accordance with various embodiments, the present technology is directed to a system for administering a reader application comprising electronic speech recognition. The system includes a microphone for recording an administrator's voice output, a speaker for listening to read material from at least one user, a memory for storing executable instructions, a processor configured to execute the instructions, the instructions being executed by the processor to administer the reader application, and a user interface for administering a reader application presented on a computer display. The user interface includes a user identifier tag uniquely identifying a user of the reader application, and a listing of a plurality of monitored reading performance metrics connected with the user identifier tag. Also included is a user-selectable list of at least one reading assistance process connected with the user identifier tag, wherein selecting an item from the list launches the respective reading assistance process comprising at least one instruction to administer the reading assistance process.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the technology so as not to obscure the disclosure with details that will be readily apparent to those of ordinary skill in the art having the benefit of the description herein.

FIG. 1 is a schematic architecture diagram of an example system constructed in accordance with the present disclosure.

FIG. 2 shows a schematic diagram of an exemplary reader system.

FIG. 3 is a flowchart of an example method of the present disclosure.

FIG. 4 is a flowchart of another example method of the present disclosure.

FIG. 5 is a flowchart of a further example method of the present disclosure.

FIG. 6 illustrates an exemplary user interface for elements of a reader application.

FIG. 7 illustrates an exemplary user interface for elements of a reader application.

FIG. 8 illustrates an exemplary user interface for elements of a reader application.

FIG. 9a illustrates an exemplary Dashboard user interface in a reader application.

FIG. 9b illustrates an exemplary Dashboard user interface in a reader application.

FIG. 10 illustrates an exemplary user interface for elements of a reader application.

FIG. 11 illustrates an exemplary user interface for administering a reader application.

FIG. 12 illustrates an exemplary user interface for elements of a reader application.

FIG. 13 is a flowchart of an example method of the present disclosure.

FIG. 14 illustrates a computer system used to execute embodiments of the present technology.

### DETAILED DESCRIPTION

The following detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter. The embodiments can be combined, other embodiments can be used, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The present disclosure provides a system, user interfaces, and methods for administrating and operating a reader application on one or more computer systems, such as an electronic book (e-book) reader system, for one or more users. In some embodiments, the system will be implemented on a network with any number of computing devices connected to the network. In various embodiments, the system and user interfaces will be designed to meet the interests and needs of a particular user type. User types may include, but are not limited to, students, peers, parents, teachers, or tutors. The user interface will offer multiple capabilities depending upon the needs and interests of the user type. In some embodiments, the user interface will present reading performance metrics for users, such as students, in a format that effectively expresses the user's reading aptitude. In various embodiments, one or more user-selectable reading assistance process may be offered in the user interface to help the user reinforce reading skills.

The user interface will support a reader application that uses speech recognition in order to detect if a user is accurately reading one or more words out loud from a given text. In various embodiments, the reader application is an electronic book (e-book) reader application.

Many people, adult and children alike, have a desire to practice reading on a regular basis. They wish to read words aloud accurately from a text. The text can be provided from any source of the written word, including but not limited to, books, articles, flashcards, pamphlets, magazines, journals, trade papers, newspapers, news, newspaper clippings, news aggregators, Internet forum messages, one or more webpages from the Internet, and any combination thereof.

The present disclosure provides a system, methods, and user interfaces for an AI-enabled reading application that uses machine learning and speech to text technology, and provides real-time feedback to the user. The application can also track the user's progress on rates of fluency and accuracy. That is, the application can indicate and also track errors that the user made while reading one or more written words that were provided to the user to read aloud. The present disclosure uses artificial intelligence and speech recognition such that a user may independently and privately learn how to read, and the user can receive feedback regarding the accuracy of their pronunciation from the reader application. Further, the present disclosure provides for tracking mechanisms to determine how many words are read per minute by the user, the amount of time the user read during that given session (i.e. a contiguous block of time a user read) or for a particular day, and to track fluency. Fluency, as used in this present disclosure, not only refers to the words read per minute by a user, but also the user's ability to articulate text with phonetically natural sound, not stilted or robotic. Furthermore, fluency addresses the ability to read with the correct voice inflection (such as in the case of reading the end of sentence versus reading the end of a question) and the ability to read with pauses to indicate the end of a sentence or a comma in the text.

The present disclosure further provides a system, methods, and user interfaces that track and improve accuracy. Accuracy is the percentage of the number of words read that was spoken accurately by the user the first time versus the total number of words read by the user. For example, if a user currently read 300 words but only 4 of those 300 words were spoken accurately the first time, then the user has an accuracy of 4/300 words times 100% which is equal to 1.33%. The accuracy metrics may be mapped against standards from State and Federal agencies.

Other tracked metrics reported in the user interface may include, but are not limited to: number of minutes spent reading per day, number of words read per day, words per/minute read per day, challenge words, mastered words (words that were “challenge words” and have been mastered by the user), persistence (number of words the user attempted more than once and then got correct), days when the user completed the warm up sequence, days within the user completed the cool down sequence, streak (the number of consecutive days the user read), suggested advice (advice given to the reader to improve abilities), location in reading material in which to continue reading, the device on which the user engaged with the application, whether a user used headphones w/microphone, and the time of day when the user used the application. Via the user interface, the user will have access to these personal metrics and will be able to view them on a daily basis, over time, and relative to peer groups. Users in each user type will be able to selectively share metrics with other people depending upon the user type. For example, a user interface for a teacher may be presented with a user interface that shows and may share a listing of multiple students and their respective metrics, which may be used to make personalized recommendations to users regarding ways to increase reading fluency and accuracy. A user interface for a student or parent may only show and share their personal metrics, along with other factors including, but not limited to visual presentation of reading material.

Additionally, the present disclosure includes a system, methods, and user interfaces that may indicate to the user the next word or punctuation that is to be read. This provides the user with support for visual tracking of the next word or punctuation to be read aloud. The present disclosure also includes a system, methods, and user interfaces to indicate to the user if they skipped a word, read a word inaccurately, failed to pause for a punctuation mark (such as a comma or period), and/or failed to use the correct inflection of voice for a punctuation mark (such as a question mark or an exclamation mark). With the present disclosure, detection of reading errors made by a user may also include tracking and storing of the words that were difficult for the user to speak. Words that were difficult for the user to speak or read aloud will be referred herein as “challenge words.” The present disclosure allows for the recording of challenge words for subsequent learning methods utilizing the present disclosure. Also, where the user correctly read aloud a word, this too will be recorded. Thus, errors that the user made while reading aloud and words that the user read correctly aloud will both be recorded in the user's own voice, such that those recordings may be replayed at a later time for educational purposes and encouragement mechanisms. Occurrences of reading errors of the user can be stored in a database. Both portions of audio segments in the user's own voice that included the errors, as well as portions of audio segments of the user reading words aloud correctly can also be stored.

The present disclosure also includes a system and user interfaces that permit users to initiate processes that offer reading assistance. In some embodiments, a process may be initiated to suggest reading material based on user-selectable preferences. Another user-selectable process may allow a user to review details of previous reading sessions, and select challenge words to review. Various other embodiments may support a process that offers one or more questions to the user during the reading process or thereafter.

These and other features of the system, methods, and user interfaces will be described in greater detail herein.

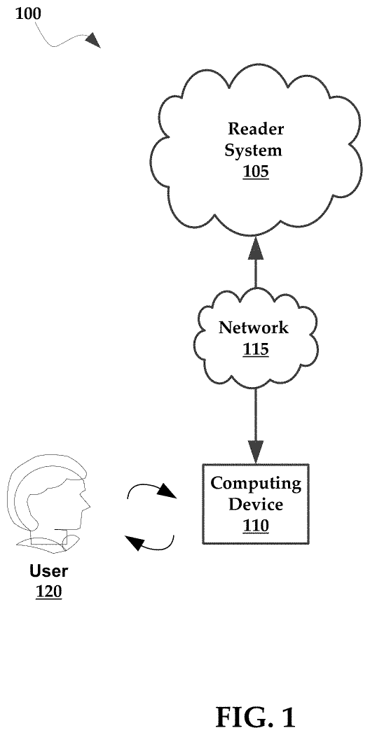

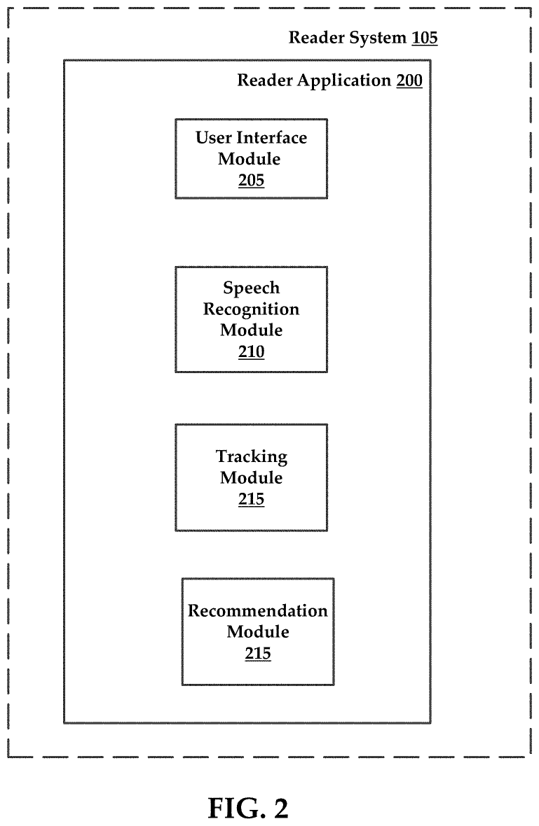

FIG. 1 illustrates an exemplary system 100 for practicing aspects of the present technology. The system 100 may include a reader system 105 that may include one or more local servers or web servers, or any combination thereof, along with digital storage media device such as databases. The system 100 may also include a network connection 115 and a computing device 110. The computing device 110 may be used by a user 120 to communicate with the reader system 105 as set forth later herein. The reader system 105 may also function as a cloud-based computing environment in accordance with various embodiments of the present technology. The computing device 110 may communicatively couple with the reader system 105 via a network 115. The network 115 is a system of interconnected computer networks, such as the Internet. Additionally or alternatively, the network 115 may be a private network, such as home, office, and enterprise local area networks (LANs). Details regarding the operation of the reader system 105 will be discussed in greater detail with regard to FIG. 2.

In general, a cloud-based computing environment is a resource that typically combines the computational power of a large grouping of processors and/or that combines the storage capacity of a large grouping of computer memories or storage devices. For example, systems that provide a cloud resource may be used exclusively by their owners, such as Google™ or Yahoo!™; or such systems may be accessible to outside users who deploy applications within the computing infrastructure to obtain the benefit of large computational or storage resources.

The cloud may be formed, for example, by a network of web servers, with each web server (or at least a plurality thereof) providing processor and/or storage resources. These servers may manage workloads provided by multiple users (e.g., cloud resource customers or other users). Typically, each user places workload demands upon the cloud that vary in real-time

The computing device 110 may be required to be authenticated with the reader system 105 via credentials such as a username/password combination, or any other authentication means that would be known to one of ordinary skill the art.

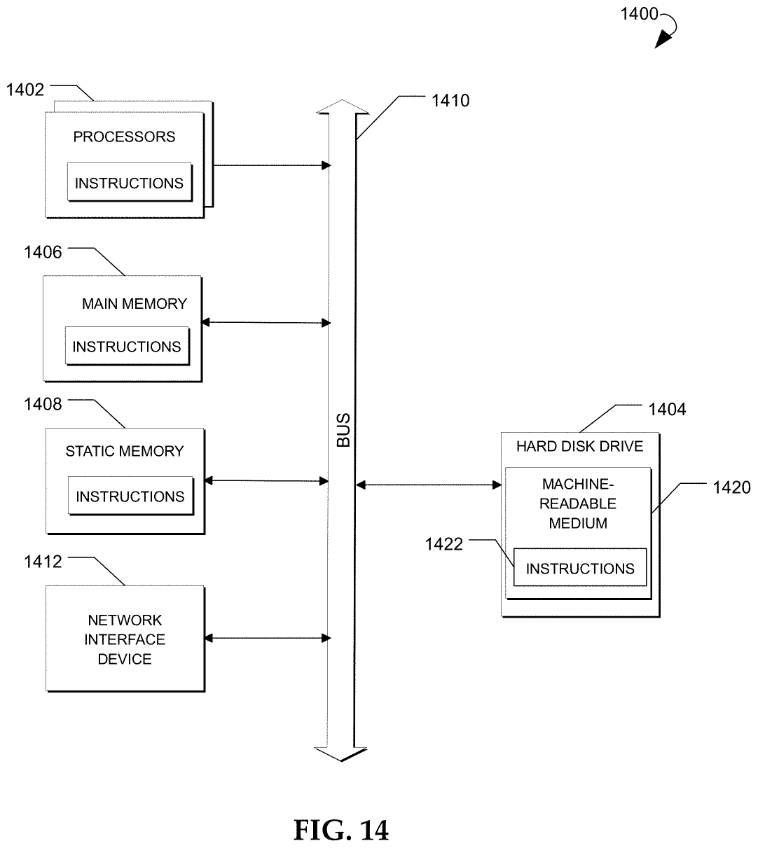

The computing device 110 include at least one of a personal computer (PC), hand held computing system, telephone, mobile computing system, workstation, tablet, phablet, e-book reader, wearable, mobile phone, a smart phone, server, minicomputer, mainframe computer, or any other computing system. Computer systems associated with the reader system 105 and the computing device 110 are described further in relation to the computing system 1400 in FIG. 14.

In some embodiments, the computing device 110 may include a web browser (or similar software application) for communicating with the reader system 105. By way of a non-limiting example, the computing device 110 is a tablet or a smart phone running a client (or other software application). Additionally or alternatively, the computing device 110 can be a PC running a web browser. Additionally or alternatively, the computing device 110 may comprise one or more of a toy (such as a computerized toy, a phone toy, a mobile toy, or a plush toy), a game, a gaming device, and the like.

FIG. 2 illustrates a block diagram of an exemplary reader application, hereinafter application 200, which is constructed in accordance with the present disclosure. The application 200 may reside within memory of the computing device 110 and/or the reader system 105. The application 200 may comprise a plurality of modules such as a user interface module 205, a speech recognition module 210, a tracking module 215 and a recommendation module 220. It is noteworthy that the application 200 may include additional modules, engines, or components, and still fall within the scope of the present technology. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In other embodiments, individual modules of the application 200 may include or be executed on separately configured web servers.

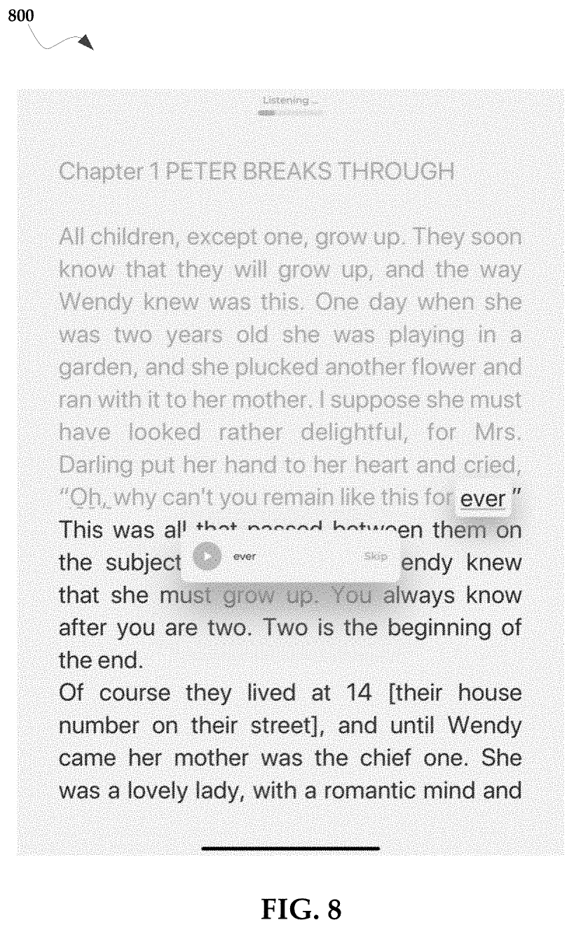

The user 120 may interact with the application 200 via one or more graphical user interfaces that are generated by the user interface module 205. Additionally, one or more written words of a text may be provided to the computing device 110 of the user 120 via one or more graphical user interfaces for the user 120 to read aloud. In some embodiments, the one or more written words of a text may be displayed on the computing device 110 of the user 120 in a way such as to mimic or mirror the appearance of one or more pages of a physical book as shown in FIG. 8. In some embodiments, the features and functions of the present disclosure can be implemented on a website or via a web application that uses an Internet connection. Some embodiments described herein use a web application that is installed on a mobile phone, but one skilled in the art can appreciate that the services can be furnished on a website that is accessible via a web browser on a desktop computer or on the mobile phone without the installation of a web application. Systems and methods described herein also can use one or more of the components of the computer system 1400 of FIG. 14.

According to some embodiments, execution of the application 200 by a processor of the computing device 110 may cause the user interface module 205 of the application 200 to transmit for display to the computing device 110 one or more written words for the user to read aloud. The one or more written words can be a portion of a given text (such as a word, a sentence or a chapter of an e-book), or the entirety of a given text, such as the whole e-book. The user will then read aloud the one or more written words into a microphone or any other audio listening component of the computing device 110. Additionally, the reader system 105 will receive an audio segment from the user's computing device 110. The audio segment comprises the user's spoken word or words captured by the computing device 110 as the user read the one or more written words. Additionally or alternatively, the audio segment comprises the user's spoken syllables and/or the user's spoken phonemes as captured by the computing device 110 as the user read the one or more written words.

Using the speech recognition module 210, the application 200 will process the audio segment by using speech recognition capabilities to determine if the user's spoken word or words match with the one or more written words that were previously transmitted for display to the user's computing device 110. As will be described later on in further detail, the tracking module 215 of the application 200 can track certain metrics associated with the user's reading of written words, including but not limited to, metrics regarding fluency, accuracy, persistence, and automaticity, as well as reading benchmarks. Also, as will be described later on in further detail, the recommendation module 220 of the application 200 will generate and transmit personalized user recommendations to the computing device 110, based on the user's profile, the user's tracked metrics, and the user's past readings or reading sessions of written words from text. Also, personalized user recommendations may be based on one or more of the user's use of warm up tool, the user's use of cool down tool, the user's use of ‘stop the clock’ guided breathing and/or stretching exercises, the time of day at which the user read, the device on which the user read, and the user's use of an additional device such as headphones with a microphone. One skilled in the art may also recognize that the speech recognition may be accomplished by local servers, remote servers, or in a hybrid manner using both local and remote servers.

A user's profile may be stored by the reader system 105. The user's profile may include one or more parameters, such as the user's reading level, age, gender, school grade. The user's profile may also store variables that change the view or operation of the user interface. For example a user may select fonts, font sizes and contrasts for written words to be displayed on the user's computing device 110. The user may choose to read text using different contrasts, such as navy on white or black on white, for visual aid. For some people, reading with a particular font, font size and/or particular contrast will increase the accuracy of their reading of the text. Thus, if the reader system 105 determines that users with similar profiles have improved accuracy in their reading that is attributable to a given font, font size and/or contrast, the recommendation module 215 of the application 200 may send a recommendation to the user to use the given font, font size and/or contrast. The recommendation may be displayed on the user's computing device 110 using the user interface module 205. By way of a non-limited example, the recommendation may say “Based on your profile and profiles of other users with similar profiles, you may wish to use Courier point size 15 font. Others with similar profiles to you had improved accuracy in their reading using this font.”

Also the application 200 can recommend that a user select a font with a heavier baseline, to help visually track. The heavier baseline of the font along the bottom of the letters may help users, such as dyslexic users, to track and read more accurately. A font with a heavier baseline appears to a user as if a regular font is applied on the top portion of a particular letter, while a bold font is applied on the bottom portion of the same letter.

Also the application 200 may allow for the user to turn on a feature called a reading wave. If the reading wave feature is turned on, while the user is reading, the reading wave can be adapted to show an emphasis on the words that the user should be placing more emphasis when reading. The reading wave can be configured to magnify or zoom in on the written words that the user should place more emphasis while reading aloud the written words.

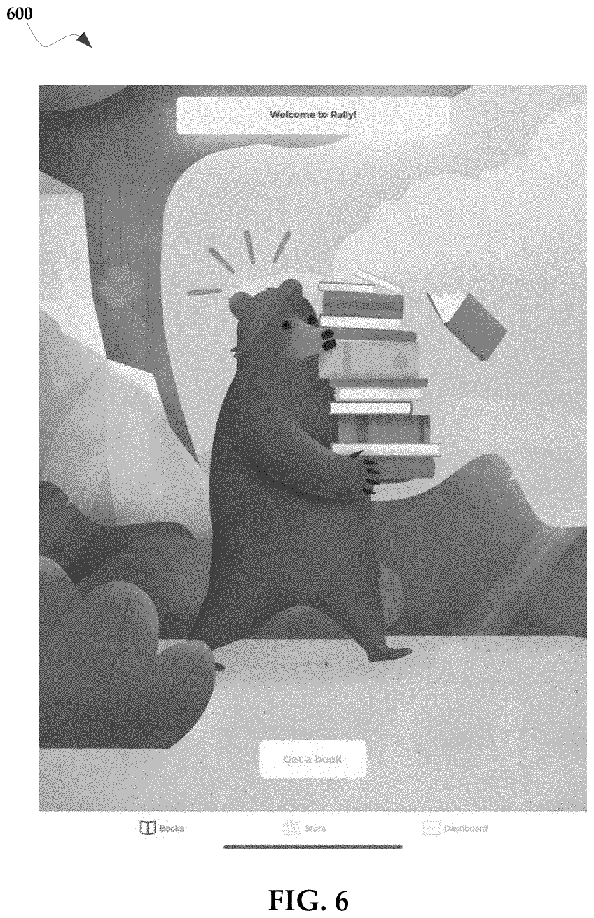

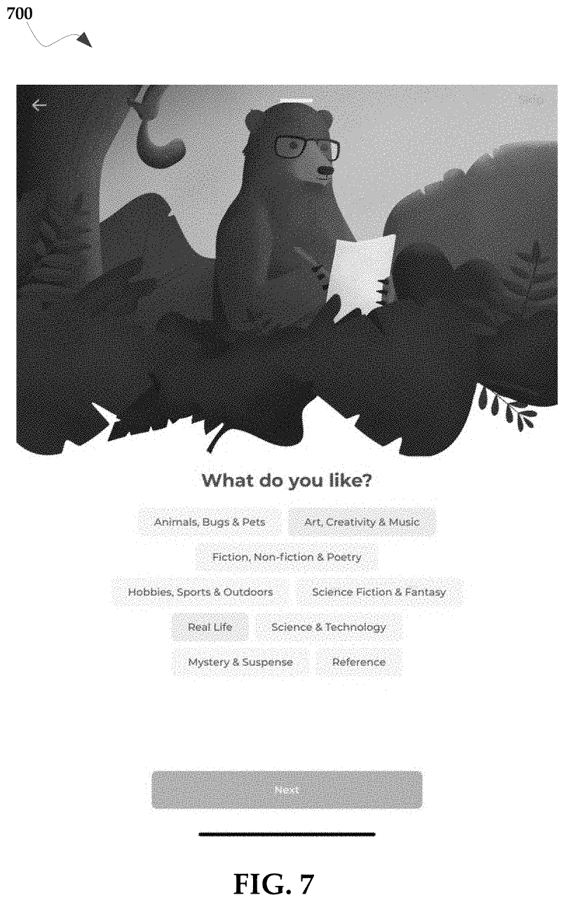

The recommendation module 215 can assist a user to select reading material, such as a book. As shown by way of non-limiting example in FIG. 6 and FIG. 7, using the recommendation module 215, the application 200 can make recommendations by topic 700. Also, the recommendation can be based on the users past readings or reading level. By way of a non-limiting example, if the child user selects a book that has a reading level that is beyond their reading level, the reader system will provide this information to the child user, their teacher and/or the child's parents, notifying them that the book selected by the child has many new words that the child has not read before. The application 200 will alert or send a push notification to the parent, indicating that the child user may struggle in reading the book. However, the application 200 is designed to allow for the user to have universal choice to select any text they wish to read, as the reader system is not designed to discourage a user from reading in any way.

The recommendation module 215 can also provide a recommendation to the child based on books that the child's teacher recommended. Also the recommendation module 215 can recommend other books to the user by assigning a personalized score to one or more texts or e-books. The recommendation module 215 can assign the score on a personalized basis based on the user's past reading, how difficult the upcoming text will be for the user to read, how many words in the upcoming text has the user read correctly, or at least what percentage of the words have the read correctly, in past readings, including the past exposure of certain written words to the user. Also the recommendation module 215 can assign the score based on how complicated the words are to pronounce in a given book and the number of syllables in the words of the text. Also, the recommendation module 215 reviews how many words in a given e-book are irregular or sight words that will be difficult for the particular user to read. Further, the recommendation module 215 can make recommendations to the user on what e-books the user should consider selecting, based on their past readings.

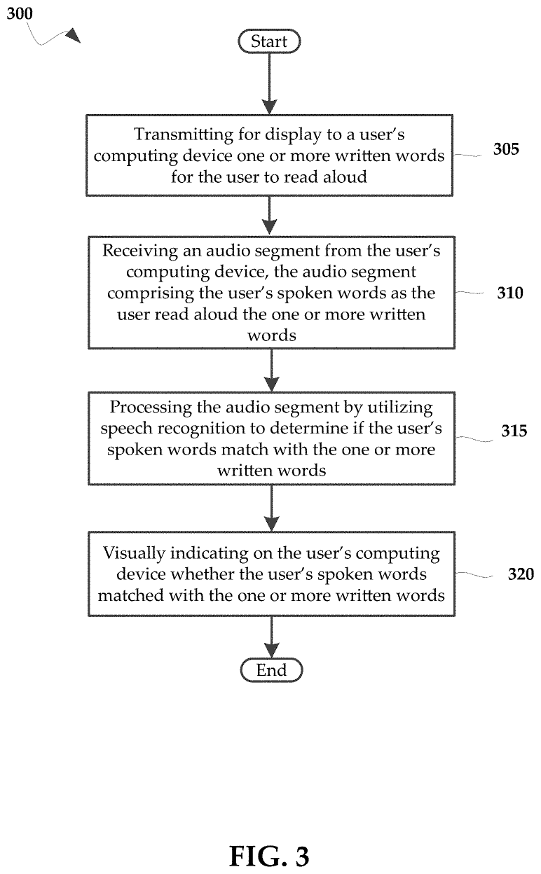

FIG. 3a is a flowchart of an exemplary method 300 for providing reading assistance to a user. The method 300 may comprise a step 305 of transmitting for display to a user's computing device one or more written words for the user to read aloud. As described previously, the one or more written words can be from any text. In some embodiments, an electronic book (e-book) or a portion of the e-book (such as a predetermined number of pages or a chapter) may be transmitted to the user's computing device. The user can then read aloud the one or more written words from the e-book. As will be described further, the user interface module of the reader system may assist the user in reading aloud the one or more written words by visually indicating which word is to be read next by the user. The visual indicator can be in the form of any visual aid, such as a highlight or bolding of the word to be read, a dot above or below the word, an underlining of the word, a different coloring of the word from the rest of the written words, and the like.

Additionally, the method 300 may comprise a step 310 of receiving an audio segment from the user's computing device, the audio segment comprising the user's spoken words as the user read aloud the one or more written words. In some embodiments, the audio segment is captured by a microphone or similar audio or listening component of the computing device. Further, the method 300 may comprise a step 315 of processing the audio segment by utilizing speech recognition to determine if the user's spoken words match with the one or more written words. In other words, the audio segment is processed using speech to text technology to see if the user's spoken (vocal) words as recorded in the audio segment match the one or more written words that the user was supposed to read. Furthermore, the method 300 may include a step 320 of visually indicating on the user's computing device whether the user's spoken words matched with the one or more written words.

If there is a match between the user's spoken words and the one or more written words, then the application will make the determination that the user accurately read the one or more written words, will measure this accuracy using the accuracy formula mentioned above, and store the accuracy measurement in the user's profile with the help of a database associated with the reader system. Also the system can store a portion of the audio segment that included the user's spoken words that matched with the one or more written words.

If, on the other hand, the application detects that at least one of the user's spoken words did not match with the one or more written words, then the user interface module of the application will visually indicate that an error occurred. The application will visually indicate which word was read aloud incorrectly by indicating which of the user's spoken words did not match with the one or more written words. Also, by way of a non-limiting example, if the user said a written word incorrectly, the error will be shown to the user by highlighting the word, underlining the word or changing the color of the challenge word so as to flag the user's attention to the challenge word.

FIG. 8 is an exemplary screen image of a page of text 800 being read on a user interface of the e-book reader system. Also indicated in the text 800 is the word incorrectly pronounced by the user, in this example, the word “ever”. A selectable popup graphical user interface element offers the user the ability to direct the system to pronounce a correct version of the word via a connected audio speaker. Also, if the user skipped a word, then the reader system will indicate that a word was skipped by highlighting the word, underlining the word or changing the color of the skipped word so as to flag the user's attention to the skipped word. If the user skipped a punctuation mark, then the punctuation mark will be highlighted the word, underlining, or the color of the punctuation mark will be changed so as to flag the user's attention to the skipped punctuation mark. For example, if a user did not pause at a comma, the comma may be highlighted, underlined, bolded or the color of the comma may be changed from black to red, so that the user's attention is drawn to the skipped punctuation mark. The present disclosure allows for a first color to be used for indicating the word to be read aloud, a second color to be used to indicate a word or a punctuation mark that was skipped, and a third color to be used to indicate when a word was mispronounced or read aloud incorrectly by the user.

The speech recognition used in the methods disclosed herein help to track reading accuracy of the user. The issue that arises when using conventional speech recognition is it has to be prepared to recognize any number of possible words that may be spoken by the user. Conventional speech recognition technology does not know what the user's next spoken word will be and so there may be a time delay in recognizing and matching the user's spoken word with one or more written words of a given text.

In contrast, in some embodiments, the speech recognition, in the system and methods disclosed herein, uses and recognizes a limited vocabulary based on the anticipated words to be spoken by the user as they read the one or more written words of a given text. This is because the speech recognition module of the application is preloaded with the written material and the vocabulary thereof prior to the user performing the exercise of reading aloud Thus, in certain embodiments of the present disclosure, the speech recognition is configured to recognize and match a limited vocabulary of words. The speech recognition module already knows and is prepared to recognize the next word that it is trying to match with the user's spoken word as the user reads the next written word aloud. Thus, the application's speech recognition module can be configured to limit the scope of the vocabulary being used to the words that the user is supposed to say next, such as configuring the speech recognition module to recognize a vocabulary set to a predetermined number. The vocabulary can be of any size, as needed. including but not limited to a vocabulary of one or a vocabulary of 10, a vocabulary of any number between 10 and 50, and so forth. The predetermined number of words can be selected from a group of one, two, three, four, five, six, seven, eight, nine, and ten words. The configurable limit of the numbers of words in the vocabulary to be recognized by the speech recognition module may be based on a number of factors including but not limited to the speed that the user is reading written words. By limiting the vocabulary used by speech recognition in the methods disclosed herein, the application is able to increase the accuracy of the speech recognition.

By way of a non-limiting example, the speech recognition module is initially set to recognize and match a vocabulary of ten words at a time. Thus, the speech recognition is rather accurate since it is expecting ten different words. The ten different words are those anticipated written words that the reader is to read next using the application. In some embodiments, the speech recognition module is configured to recognize similar phonemes. In further embodiments, the vocabulary may be adjusted, based upon a detection by the application that a user has paused. That is, if a user pauses while reading aloud one or more written words, during those pauses, the speech recognition can continue to build the vocabulary. The building of the vocabulary may be based on anticipated written words as presented in a given text (such as the next two pages of an e-book).

Yet another aspect of the speech recognition used in the present disclosure is that it can accept a syllable by syllable, or phoneme by phoneme, input from the user, filter the syllables or phonemes as spoken by the user, pass these syllables or phonemes as sounds to the speech recognition module, and by utilizing speech recognition, reassemble the syllables to detect the word that is being said by the user. In particular, the speech recognition determines if the collective number of syllables matches a given word. Conventional speech recognition cannot perform this reassembly of syllables or phonemes and recognition. An example of this would be a user reading aloud the word “phenomenon.” As the user is speaking each syllable of the written word, syllable by syllable, the speech recognition would reassemble the syllables to detect the word “phenomenon.” In further embodiments, the speech recognition of the application can synthesize a user's spoken phonemes and/or spoken syllables (which may be considered as parts of a whole word), such that the spoken phonemes and/or spoken syllables are transformed into whole words (which can be viewed as the user's spoken words of the one or more written words). This can indicate reading accuracy.

A further aspect of the speech recognition used in the methods presented herein is that the speech recognition module can determine, based on the advanced presentation of written words, which written words may be more difficult for the user to pronounce. The speech recognition module of the application determine this based on a number of factors, including but not limited to, the user's previous challenges or difficulties in reading a particular word, the complexity of the word, and a review of the user's fluency score relative to a fluency score of one or more similar users (whose profiles are similar to the user) who had difficulty with that same word The speech recognition may “look ahead” to upcoming text that is to be read by the user, and may extract written words from the upcoming text which are likely to be more difficult for the user to read and/or pronounce. The speech recognition module analyzes the user's previous reading performance to determine if the user had been exposed to the word or had trouble reading the particular word. The module also considers the complexity of the word, the difficulty to a group of users with a similar reading level capability of reading the word. The module determines if one or more written words in the upcoming text will be more difficult for the user to read aloud.

It should be noted that complexity of a word may be represented in different forms. Sometimes the complexity of a word is due to the word being multisyllabic, like the word “phenomenal.” Sometimes the complexity of a given word is because it does not follow pronunciation conventions, such as sight words. An example of this is the word “gnome.”

It should also be noted that this application can provide reading assistance to users who have learning differences. For instance, dyslexic children who may use this application to practice their reading may skip words, so the application has a feature indicating the written word that was skipped. Furthermore, for a dyslexic child, currently the only true feedback they receive is from a teacher who measures the time to read one or more written words and who notes the reading errors that the child made during that timed reading. These timed reading sessions are infrequent, which impacts their benefit to the child

Dyslexic children need to practice on a regular basis, to improve their reading skills, and they need to be able to practice reading independently. Most dyslexic children also want to know if their reading is improving over time, and how many words they read correctly in a given reading session. The present disclosure addresses these needs of dyslexic children, by providing them a vehicle to practice reading independently on a regular basis and providing them also with their accuracy and fluency metrics.

Dyslexic child users will benefit from the present disclosure since with the reader application, the users can see their data in real time and track their progress. The data regarding the user's reading skills as obtained by the systems described herein are far more accurate than the data collected by a child's teacher in a timed reading. A user can also see trends concerning their reading accuracy and fluency based on their usage of the application. For instance, by way of a non-limiting example, a user may see that if they only read twice a week without a warm up sequence, they may not have improved, but if they read three times a week with a warm up sequence and a cool down sequence, the user may discover that their reading skills improved. Also a user can see that users with similar profiles saw a huge improvement if they read consistently using the application. The application will also prescribe to the user a number of reading sessions per week to realize significant reading skill improvement based on users with similar profiles. Further, based on users with similar profiles, the application might recommend that the user read for a given number of minutes per day or per week, to realize significant improvement in their reading skills.

In some embodiments, the application may also recommend to the user to add warm up sequences and/or cool down sequences, based upon the reading improvements experienced by users with similar profiles who did warm up and cool down sequences. By way of a non-limiting example, after a week of contiguous reading by the user, the application will provide a personalized recommendation. For instance, the application may provide a message to the user that states: “You did great this week, here's how you did.” Then the application will provide the user with their statistics regarding accuracy and fluency metrics recorded for week. The application may also provide a personalized recommendation to the user for future reading sessions.

Also, a user may be encouraged by the application to continue reading a predetermined level of reading day to day, so that they can maintain a streak. The application will measure and store the time spent by the user in actively reading using the application, and this information may be depicted to the user in the form of a progress bar in the user interface 900. By using a progress bar, the user can see how much active reading they should be doing for that given day to maintain their reading streak.

Also, in addition to giving feedback, providing recommendations and encouraging users to read, the system can determine if the user is frustrated by the stress indicators in their voice. If the user is stressed or if the user says “time out”, the application may stop the clock, or give the user the option to stop the clock. Thereafter, the application may make a recommendation to the user to perform a guided breathing exercise, a stretching exercise, or some other mechanism to help the user relax, and eventually return to reading aloud after the user is not so stressed. Such breaks suggested by the application may improve the user's reading results and accuracy. The guided breathing exercise may include a physical component, such as having the user tap his/finger to synchronize inhalation and exhalation. By way of a non-limiting example, the application can indicate to the user that the user should inhale while tapping his/her finger to a count of four, hold one's breath while tapping one's finger for a count of four, and exhale while tapping one's finger to a count of six. Multi-modal or multi-sensory techniques can be particularly effective in teaching people with learning challenges like dyslexia. The application will track whether the guided breathing or stretching exercises had an impact on the user's reading accuracy or fluency.

Also for child users of the present technology, the system, user interfaces, and methods disclosed herein for providing reading assistance allow for parents of child users to track and be assured that their children are reading regularly for a set number of minutes of a given day. In other words, the system measures and tracks the number of minutes that a child user reads using the application. The system also may provide a push notification to the parent if the child is struggling with their reading session, based on the system's ability to detect and track the child's reading accuracy in real-time. In particular, the system can detect if the user has stress indicators in their recorded voice, in real-time, while using the reader application to read written words aloud. If the child is stressed while using the application and this is detected by the application, the application will send a timely push notification to the parent that the child is stressed and that the parent may wish to check on the child at that time.

The application tracks user reading accuracy which is useful for reading improvement. A warm up sequence and cool down sequence helps improve accuracy and reduce reading errors.

The warm up and cool down sequences address a common issue for people who are learning how to read and people who have learning differences, such as dyslexics, which is the issue that information on how to read certain words may be stored in the user's short term memory in their brain. It may take a longer period of time for this information to enter into a user's long term memory. Building automaticity, the ability to see words and read them quickly, is important to increase accuracy and fluency in reading, so with a warm up exercise, a person may have a higher chance of reading words correctly, increasing their reading accuracy, and building their reading comprehension.

In other words, a user may launch the application on their computing device, and prior to reading written words from a text (such as an e-book), the user is provided with a warm up sequence first that includes one or more virtual flashcards or cue cards that are displayed on the display of the user's computing device. The flashcards or cue cards may each show a word. During the warm up sequence, the user is given an opportunity to practice words that were difficult to read based on the tracking of words that the user read incorrectly in the past. Also, the warm up exercise may include words that other users with similar profiles have read incorrectly in the past or words that the user has not encountered before. The difficult words that may be presented to the user for them to practice in a warm up exercise may be challenge words. In some embodiments, if the user completed the cool down sequence in the prior session, and answers to questions were recorded, then the next day's warm up session will include the option to listen to the recorded responses that the user made during the prior cool down session. Cool down questions, followed by a user's audio response may include questions that test the user's reading comprehension, such as “what was the main idea in the text you read?” or “What do you think will happen next in the story?”.

Furthermore, the warm up exercise is personalized based on the user's reading level and the user's past readings. The challenge words may include words that the user will encounter in the upcoming pages of the text to be read, such as the upcoming 10 pages of an e-book. Also the user may be limited to a predetermined number of attempts in which to read a challenge word aloud before an audio pronunciation process in the application will read the word to the user. The value corresponding to the permissible number of attempts may be assigned based on the user's reading level.

If the user exceeds the number of attempts to accurately read a written word, the application will provide the user with options to initiate several additional reading assistance processes. The application will provide the user with the option to show the user a syllabic or phonetic version of the word, the option to skip the written word, the option to show the user a syllabized version of the word, the option to hear the word said correctly by the user in the user's own voice if the user has previously read the word aloud correctly, the option to hear the written word pronounced by the application, a phrase or a sentence, the option to be prompted with a rhyming word, and any combination thereof.

By the end of the warm up sequence, the user has been reminded how to pronounce the challenge words for the user's upcoming reading session. Once the warm up sequence is complete, the application will display the written words of the text where the user last finished reading.

The application also improves and builds the user's automaticity of words by repetition of exercises. Thus, by way of a non-limiting example, if the user sees the word “gnome” in the first warm up sequence, in the one or more written words of the text during a first reading session, in the first cool down sequence, and also during a second warm up sequence associated with a second reading session, automaticity regarding the word “gnome” may be improved For some users, they must see the word a number of times before they can automatically recognize the word.

It should also be noted that the reader system is “listening” or determining how quickly the user read the word aloud correctly. If the user read a word such as “gnome” correctly and rapidly a certain number of times, then the reader system will gauge that and it may take the word off the list of “challenge words” such that the word “gnome” will not be presented in the following warm up sequence. Similarly, with a multisyllabic word such as the word “phenomenal,” the word may be included in a warm up sequence and a cool down sequence to build a user's automaticity. Users may be required to read a challenge word correctly and rapidly several times before the user is considered “fluent” in that word, allowing it to be removed from that user's list of challenge words. The application will determine how many times a user needs to read the challenge word fluently before that word should be removed from the challenge list.

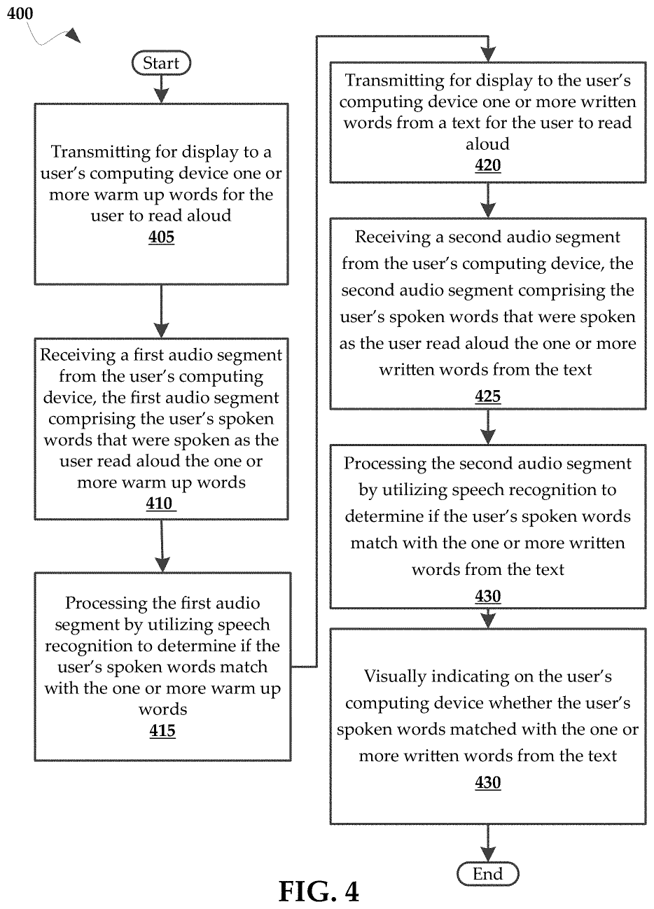

FIG. 4 is a flowchart of a further exemplary method 400 for providing reading assistance to a user. This exemplary method 400 provides the steps for a warm up exercise and a reading session in accordance with various embodiments of the present disclosure. The exemplary method includes a step 405 of transmitting for display to a user's computing device one or more warm up words for the user to read aloud. The method may further include a step 410 of receiving a first audio segment from the user's computing device, the first audio segment comprising the user's spoken words that were spoken as the user read aloud the one or more warm up words. The method continues with a step 415 of processing the first audio segment by using speech recognition to determine if the user's spoken words match with the one or more warm up words. The speech recognition can be adjusted based on the words per minute being read, so the speech recognition function can be configured and set to process any given number of words, such as 100 words per minute or 10 words per minute.

The method 400 further includes a step 420 of transmitting for display on the user's computing device one or more written words from a text for the user to read aloud. The method 400 may also include a step 425 of receiving a second audio segment from the user's computing device, the second audio segment comprising the user's spoken words that were spoken as the user read aloud the one or more written words from the text. The method 400 may continue with a step 430 of processing the second audio segment by utilizing speech recognition to determine if the user's spoken words match with the one or more written words from the text. Finally, the method 400 concludes with a step 435 of visually indicating on the user's computing device whether the user's spoken words matched with the one or more written words from the text.

In some embodiments, the exemplary method 400 may include steps for providing a cool down sequence to the user. The cool down sequence is meant to help the user review challenge words, which may include words that they struggled with or had difficulties in reading accurately during the reading session. The cool down sequence includes the steps of transmitting for display to the user's computing device one or more cool down words for the user to read aloud; receiving a third audio segment from the user's computing device, the third audio segment comprising the user's spoken words that were spoken as the user read aloud the one or more cool down words; and processing the third audio segment by utilizing speech recognition to determine if the user's spoken words match with the one or more cool down words.

In a cool down sequence, the application may provide virtual flashcards or cue cards of challenge words, based on last portion that the user read. Also, in a cool down sequence, the application may also provide an audio prompt where the user is asked a first question such as “What was the big idea of this text?” Then the user can press the record button on the graphical user interface of the application using their computing device. Once the user has recorded their answer, the user's answer to the first question can be converted into text. The user can also be presented with a second question during the cool down sequence, such as “What do you think will happen next in the story?” The user will have a chance to respond to this question and the user's recorded answer to the second question can also converted into text. Then, in the next day's warm up sequence, these two pieces of information or answers of the user can be used as refreshers, such as to remind the user where they were at in the text last time. In further embodiments, the user may answer a multiple choice question posed during the cool down sequence by the application by selecting one of the multiple choice answers provided to the user, and the user's response can then be recorded.

Further, based on the user's feedback of the story as set forth in their answers to the two questions presented in the cool down sequence, that information can be part of the push alert that can be delivered to teachers, parents, and/or coaches. For instance, the child's response to “What was the big idea of this text?” may be forwarded to the child's parent, so that the child's parent can ask the child about the text they read using the application, perhaps during dinner time later that evening. Also, the application may use heuristic learning and speech to text technology of the child's feedback, as stated in their answers to the two questions presented in the cool down sequence, to determine whether the child comprehended the text that they just read during the reading session that preceded the cool down sequence.

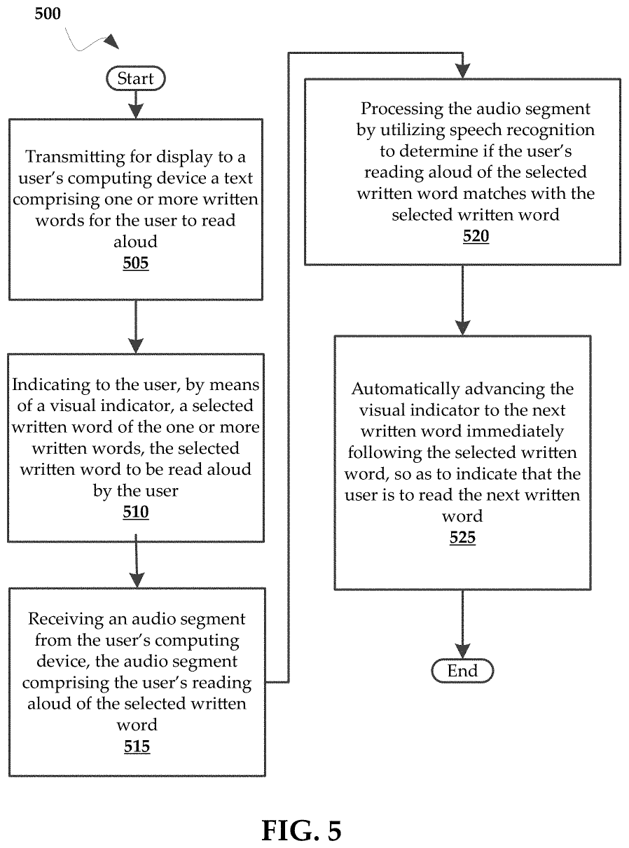

FIG. 5 is a flowchart of another exemplary method 500 for providing reading assistance to a user. The exemplary method 500 begins with a step 505 of transmitting for display to a user's computing device a text comprising one or more written words for the user to read aloud. The exemplary method 500 further includes a step 510 of indicating to the user, by means of a visual indicator, a selected word of the one or more written words, the selected word to be read aloud by the user. The method 500 also includes a step 515 of receiving an audio segment from the user's computing device, the audio segment comprising the user's reading aloud of the selected written word. The method 500 then includes a step 520 of processing the audio segment by using speech recognition to determine if the user's reading aloud of the selected written word matches with the selected written word. The exemplary method 500 concludes with a step 525 of, upon determining that the sounds of the user's reading aloud of the selected written word matches with the sounds of the selected written word, automatically advancing the visual indicator to the next written word immediately following the selected written word, so as to indicate that the user is to read the next written word. Further optional steps include upon determining that the sounds of user's reading aloud of the selected written word do not match with the sounds of the selected written word, by speech recognition, transmitting for display to the user's computing device a notification that the user did not read the selected written word correctly; and transmitting for display on the user's computing device one or more options for the user to select, the options comprising an option for the user to read aloud again the selected written word, an option for the user to receive additional assistance from the application, an option for the user to skip the selected written word altogether, and an option for the selected written word to be read aloud to the user by the application via the user's computing device.

By way of a non-limiting example, imagine that the sentence to be read by the user in the text is “The glass is half full.” The visual indicator in the user interface will first indicate the user is to read the word “the.” Once the reader system has received an audio segment comprising the user's reading aloud of the word “the,” then the visual indicator will automatically advance to the next written word of “glass,” since the word “glass” immediately follows the word “the.” In other words, at that time, the word “glass” will be highlighted in a different color, highlighted, underlined or somehow visually indicated as the word to be read next. The visual indicator will remain on the word “glass” until the word “glass” is read aloud by the user. In some embodiments, the visual indicator will advance onto the word “is,” which is the next word following the word “glass,” regardless if the user reads the word “glass” correctly the first time. In other embodiments, if the user does not read the word “glass” correctly for a set or configurable number of times for the user to attempt to read the word correctly (for instance, three times), then the user has the option to ask the application for the word “glass” to be read to them.

The set number of times for a user to read a given word may be based on the reading level and/or age of the user. For instance, a young user may be given two tries, whereas a more mature reader may be given five tries. This has to deal with a feature in the application called a “stuck indicator.” The stuck indicator is a configurable way to allow a user to advance in a text (such as an e-book), whether they read a written word correctly or not, with one or more configurable number of times for the user to attempt to reach the word. If the user fails to read the written word correctly, then the reader system will record the spoken word matched with the written word on the page, so that every sound bite is recorded along with the written word, for future learning, optimization and data collection.

If a user struggles with reading a written word, and they are stuck, the stuck indicator feature provided by the application will provide the user with several options if the user clicks or taps on the written word displayed on their computing device. The user can choose the option of hearing a phonetic sounding of the word. The user can choose the option of hearing the word cut into phonemes or syllables, as one would see in a dictionary, so that the user can be encouraged to try again to read the written word. In other words, voice recognition may be used on a syllable by syllable basis to determine if a person accurately pronounced a complete word. The user may choose the option of hearing a recording of their voice saying the word correctly, if in the past the user read the word correctly. The user may also choose the option of hearing a prompting phrase, such as “the word rhymes with . . . ” So, if the written word that the user is struggling to read aloud is the word “cat,” then the user may select the option of hearing a prompting phrase from the application, such as “the word rhymes with the word ‘hat.’”

In some embodiments, a reading score may be determined based on the measured time for a user to read a portion of the reading material, a measured effort required to read the portion, and a measured difficulty of the portion of the reading material. The product of these elements produces a score that can be compared and standardized with other users reading the same material.

In various embodiments, the reading score will be an equation that includes, but is not limited to, the following variables: amount of time the user read, accuracy (percent of words the user got correct on the first attempt), persistence (percent of words a user eventually got correct, regardless of the number of attempts required), the difficulty level of the book being read, the difficulty level of the passage within the book compared to the user's established reading level. In some embodiments, users will earn points based on their reading score, on completion of warm-up and cool-down exercises, completion of questions, and other desired user behaviors such as, but not limited to sharing reading stats with a parent or teacher, reading for multiple days in a row(streak), completing a book, etc. These reading scores may be standardized to evaluate the effectiveness of various teaching methods used.

Also, the application includes the optional feature of word zoom. If the user makes an error repeatedly in reading a written word, such as in the case of inaccurate pronunciation of a word, or based upon user input (such as the user tapping on a selected written word that they are struggling to read), the written word can grow in font size in the user interface such that the reading environment becomes a visual distraction-free environment, thereby allowing the user to “zoom in” on the written word and focus on the written word, to increase reading accuracy. The written word that is selected by the user to “zoom in” is enlarged in a font size such that the written word appears to be bigger in size than any of the remaining written words. This option of word zoom can be turned on or off by the user.

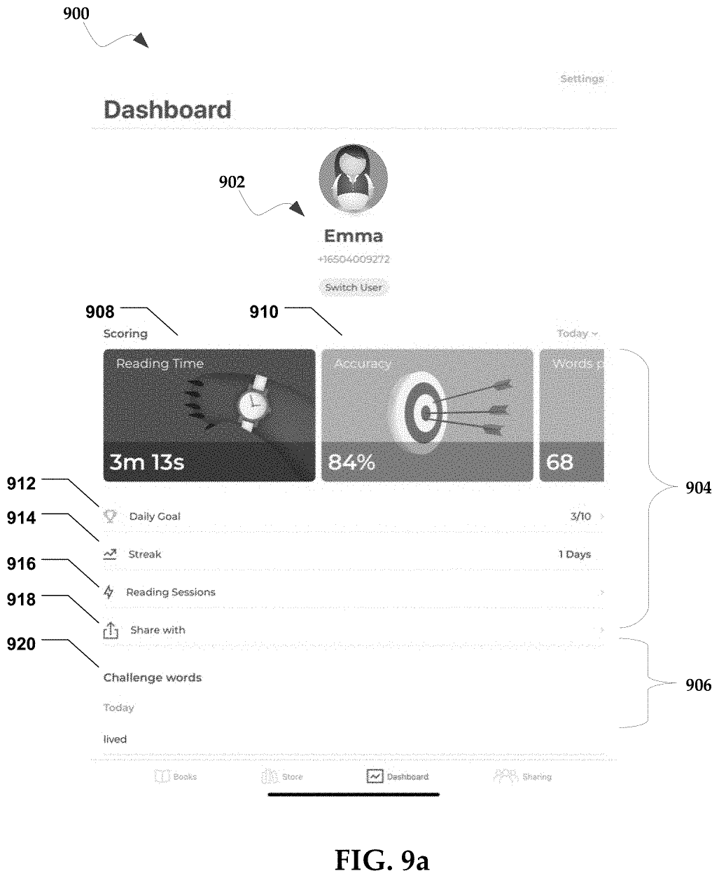

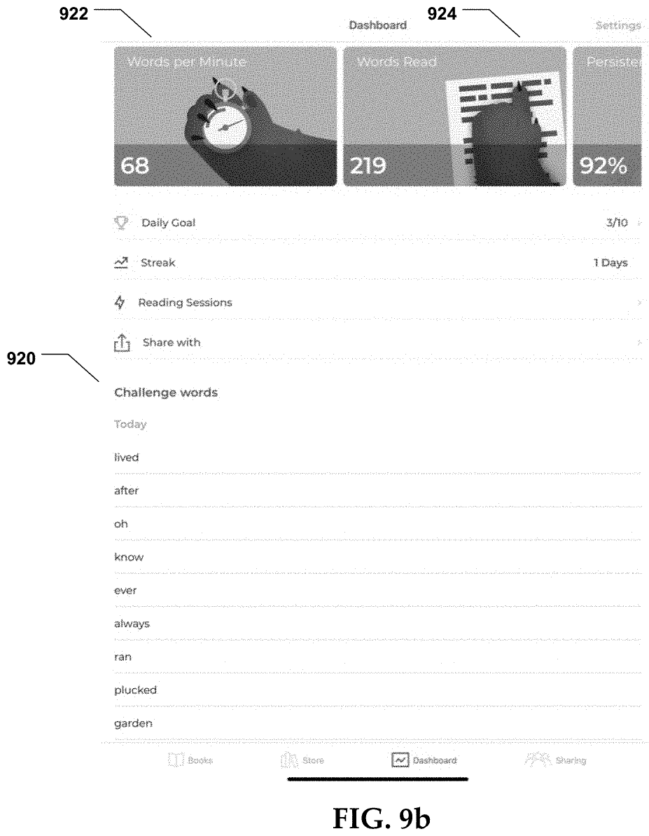

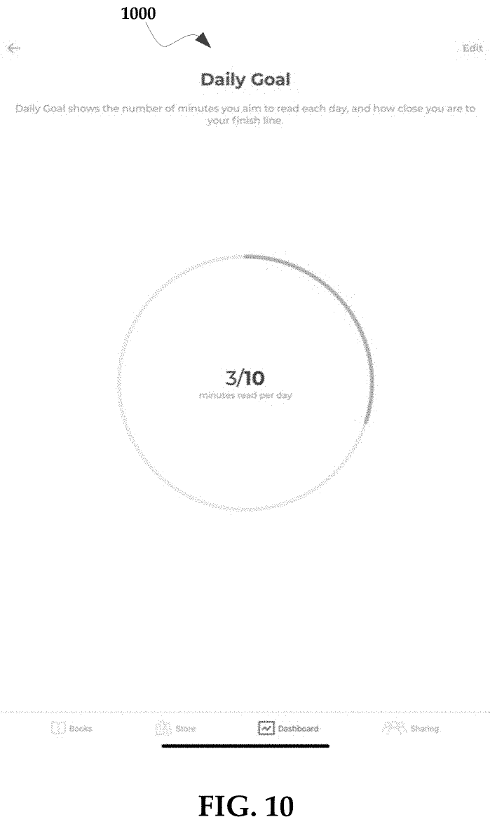

As described above, user types may include, but are not limited to students, peers, parents, teachers, tutors, or system administrators. The user interface module 205 will offer multiple capabilities depending upon the needs and interests of the user type. In various embodiments, the configuration of the user interface prepared by the user interface module 205 will differ based upon the computer configuration, the display characteristics, and the intended user type. By way of non-limiting example, the user interface of the reader application for a device, such as an e-book reader, may be configured as a “Dashboard” that provides overviews of performance metrics and user-selectable processes of a reader application. In another embodiment, the Dashboard presented to a person administering the reader application to a group of users may provide overviews of performance metrics of multiple users and user-selectable processes to administer the reader application. In some embodiments, the user interface module 205 will present reading performance metrics for users, such as students, in a format that effectively expresses the user's reading aptitude. In various embodiments, one or more user-selectable reading assistance processes may be offered in the user interface to help reinforce reading skills of the user. FIG. 9a shows an exemplary user interface 900, configured as a Dashboard, for a student user. The user interface 900 may be divided into multiple portions, such as frames. In one portion, one or more user identifier tags 902 may uniquely identify a user of the reader application on a computing device, such as an e-book reader system. By way of non-limiting example, in FIG. 9a, a name, “Emma”, and a user identification number, “16504009272”, uniquely identifies the user. In some embodiments, the user identifier tag(s) may be assigned by a person administering the application (such as a teacher), assigned by the user, assigned by the system automatically, or some combination thereof. For example, the user may identify herself as “Emma” to the system, while the system assigns her a unique identification number to distinguish her from other users with the same name. In various embodiments, a listing of a plurality of monitored reading performance metrics 904 for the user identified by the identifier tag 902 may be presented in another portion of the user interface 900. The list of performance metrics 904 may be displayed in a scrollable format, for example, as shown in FIG. 9a and FIG. 9b. Various performance metric values are shown that the user can view by scrolling left or right using physical swiping actions on the display of an e-book system that supports a swiping feature. By way of non-limiting example, the viewable performance metrics 904 may include reading time 908, accuracy 910 (i.e. the percentage of words read correctly on the first try), words per minute 922, words read 924, persistence (i.e. the percentage of time the student repeatedly attempted to read the word correctly and finally succeeded), and other metrics. Metrics may also be displayed in other non-scrolling list formats, as shown in FIG. 9a and FIG. 9b. Daily goal 912, streak 914, and reading sessions 916 metrics are listed in a non-scrolling format in the user interface 900. In some embodiments, the daily goal 912 may be expressed as the period of actual reading divided by the goal set for the reading period. A process, activated by a tap on a listed item or graphical user interface element, for example, may initiate a process that allows a user, such as an administrator, or teacher to set the daily goal. In various embodiments, the goal may be set by the reader application using a predetermined value or process. FIG. 10 shows a graphical representation of an embodiment of the daily goal metric following a “tap” (selection) on the “daily goal” item from the user-selectable list using a mouse curser, finger (touchscreens), or stylus (touchscreens). In some embodiments, an icon or other selectable graphical user interface element is used to enable editing of the user's daily goal. The streak 914 value list item indicates the number of consecutive days a student read or met their daily goal. In some embodiments, user selection of the reading sessions 916 list item may display a record of a consecutive reading period measured for the student. The period of consecutive reading may indicate reading endurance of the student. Other list items may not show metrics, but be informative. One such list item entitled “share with” 918 allows the user to share recorded metrics with other users. The user interface will permit the user to enter a name or electronic address of the recipient of the shared metrics. By way of non-limiting example, a user-selectable listing of users may be presented in a popup menu, or a field may be presented that allows typing of an identifier tag 902 or other unique user identifier to which the information is to be transmitted.

In various embodiments, a user-selectable list of at least one reading assistance process may be presented in another portion of the user interface 900. Selecting an item from the list launches the respective reading assistance process. By way of non-limiting example, reading assistance processes may include computer instructions to prepare a user interface for a user to practice challenge words 920, to display screen recordings, to display questions, and other processes. User selection of a particular challenge word in a displayed list may activate a process that permits the student to practice correct pronunciation of the challenge word. FIG. 9b shows a user interface 900, configured as a dashboard, having a list of selectable challenge words 920. Selecting the screen recording list item, not shown in the figure, may activate a process having instructions to display one or more screen recordings of user reading activity. The user may see the text read, error words may be visually identified, and the user may play the recording to hear the student reading a particular passage of text.

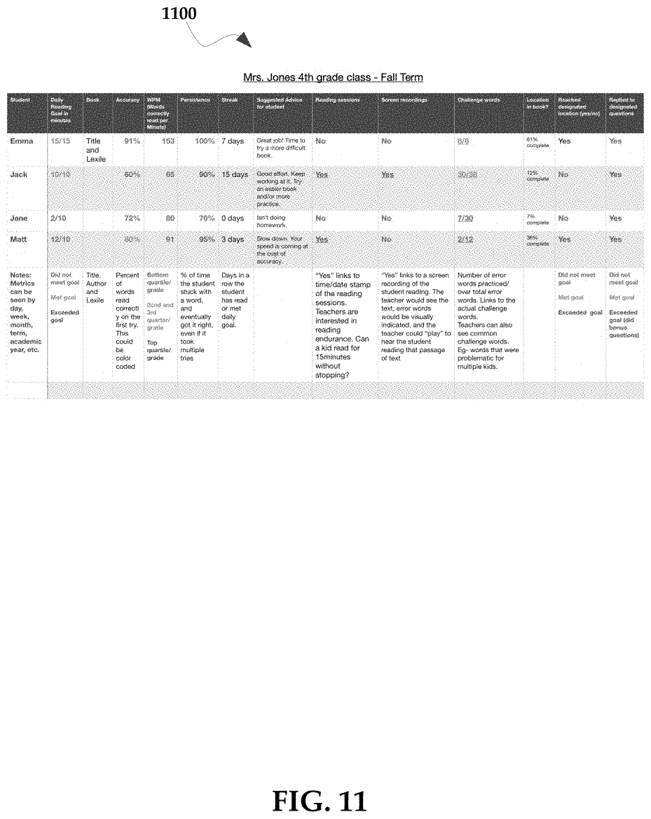

In various embodiments, the user interface module 205 may prepare a user interface designed to be used by a person administering the reading application. Example users include a system administrator or a teacher. FIG. 11 shows an exemplary user interface 1100 to be used to monitor and administer a reader application to a group of student users of computing devices, such as e-book readers. By non-limiting example, the user interface 1100 shown in FIG. 11 is in table format. In some embodiments, user interface formats realized by the interface module 205 for administering the reader application may display graphs, have pull-down menus, popup dialog boxes, and other user interface elements. The user interface may be a dashboard user interface similar to the example shown in FIG. 9a and FIG. 9b, but with expanded capabilities to administer the reader application. Other forms of user interface for administering the reader application may vary depending on the user. For example, a parent user may need administration capabilities different from the administration capabilities of a teacher user, and these differences would be reflected in user interface elements available within the user interface. For example, a teacher may need a capability to insert a reading comprehension question at a position in the text, while a parent may not need such a capability and therefore would not have the option available in the user interface.

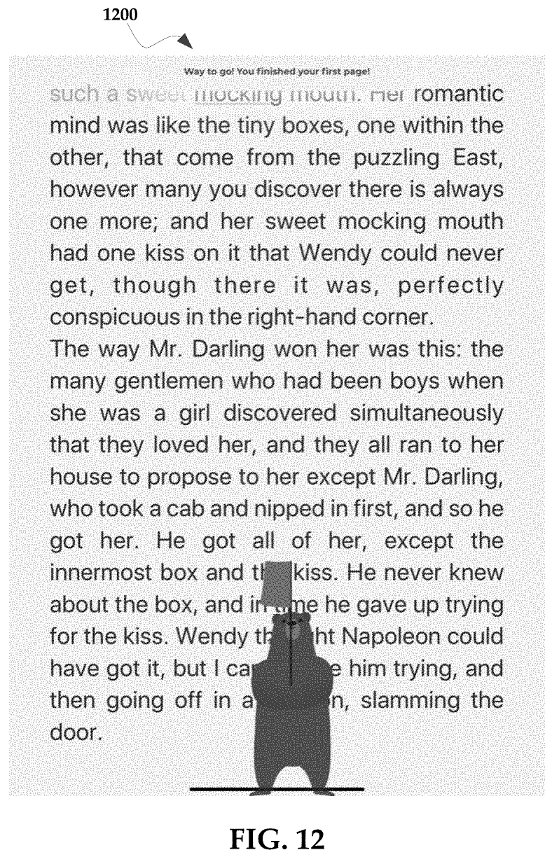

In some embodiments, the period of view for the recorded data within the user interface for administering the reader application can be by day, week, month, term, academic year and other such measures of time. Student user identifier tags are listed in one portion of the user interface 1100, tracked performance metrics are listed in one or more second portions, while user-selectable reading assistance processes are listed in one or more third portions of the user interface 1100. By way of non-limiting example, the tracked performance metrics may include daily reading goal, book title, accuracy, words correctly read per minute, persistence, streak, reading sessions (indicating time/date of the sessions), screen recordings, location in the book (e.g. percent completed), whether a student reached the designated location in the text, and whether the student replied to the designated questions. In some embodiments, along with a confirmation of screen recordings having been recorded, the user interface 1100 provides a user-selectable process having instructions to play video and audio recordings of a student reading problematic text that also identifies challenge words using electronic speech recognition. In various embodiments, the user interface may support automatic color coding of metric data to help identify students meeting or exceeding objectives and those students not meeting specified objectives. The color coding may be based on the value of a metric meeting or exceeding a predetermined threshold value. For example, with regard to the daily reading goal, a value for a metric showing that the goal has been met is color coded green, and those values that exceed the goal are color coded blue, while a value indicating that a goal has not been met is color coded red. In various embodiments, the color coding can also indicate a level of achievement. For example, in FIG. 11, the WPM metric indicates the number of words correctly read per minute of reading time. A blue color code indicates a top quartile/grade, a green color code indicates a 2^{nd} & 3^{rd} quartile/grade, and a red color code indicates a bottom quartile/grade. By way of non-limiting example, the reading assistance processes shown in FIG. 11 include the challenge words, suggested advice for the student, and initiation of a question/answer process. Challenge words for each student and the number of those words practiced can be viewed and compared by the teacher. For example, the value shown in FIG. 11 indicates the number of challenge words practiced by the student per total number of challenge words determined for the student, for example “2/12”. Challenge words common among multiple readers may be singled out for additional practice during group learning. A user-selectable list item in the user interface of FIG. 11 initiates a reading assistance process having one or more administering instructions to provide teachers with a capability to provide comments and reading advice to students. By way of non-limiting example, a message to a student may be entered into a field in the user interface 1100, and transmitted to the computing device, such as an e-book reader, used by the student user and displayed in a popup window. FIG. 12 shows a popup window in the user interface of a reader application providing a congratulatory message 1200 to the student user. The message may also be stored in a database by the reader application and accessed and viewed by the student user at a time convenient to the student user. In some embodiments, the displayed message may also be automatically generated by the reader application in response to an event trigger, such as meeting a goal such as reading an entire page of text.

In various embodiments, questions to be answered by a student user may be inserted into discrete locations within the body of the text. By way of non-limiting example, the questions may test reading comprehension and be formulated by a teacher. A user selectable list item in the user interface for the reading application may contain one or more instructions to administer the list item. By way of non-limiting example, the process may include instructions to display a text entry field in the user interface to allow the teacher to enter the question, and additional instructions or processes may provide the capability to specify the location within the text, and the manner in which the question is to appear. The question may be stored in a database by the reader application, and linked to text to be read by the user. The questions may be linked to a discrete location within the text, such that the question may appear in a popup dialog box, a designated frame in the application, a popup or new window, or any other graphical user interface element supported by the computing device. For example, one or more questions may appear on the display when a student reads the word at the discrete location in the text in which an event trigger has been placed. Alternatively, the question may appear in response to an event trigger by turning a virtual page of text. Answers to questions may be scored by a teacher, or they may be scored automatically by the reader application according to a scoring resource available to the reading application. By way of non-limiting example, the scoring resource may be a scoring rubric in electronic format. The reader application may also use machine learning to determine the correct answer based, in-part, on statistical analysis of answer data received from other users. Scores may be displayed in the reader application on an e-book reader system, stored on the system, or transmitted through a computer network to one or more systems operated by the student, a parent, or other entity.

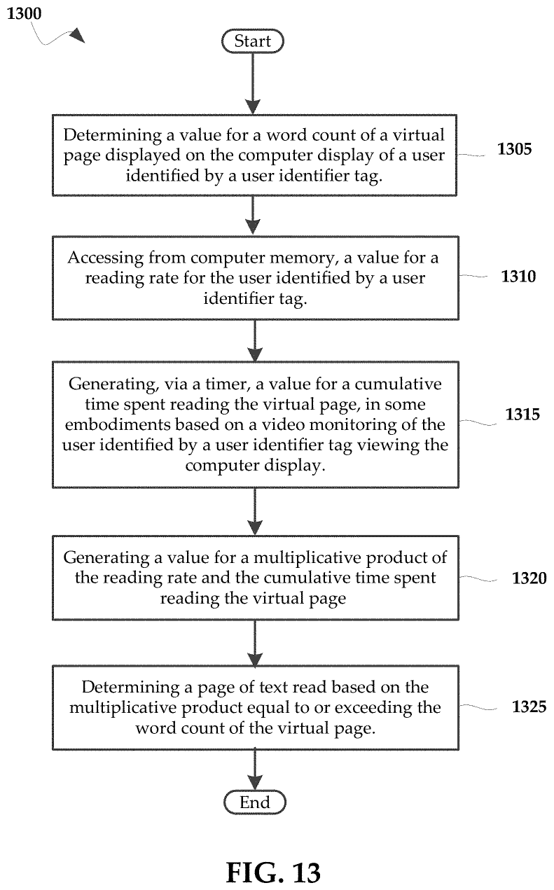

FIG. 8 is an exemplary screen image of a page of text 800 being read on a user interface of the e-book reader system. In some embodiments, a user can advance to additional pages of text by “swiping” the screen image. In various embodiments, a “swipe lock” feature may be implemented to limit the rate of page advancement by the reader to help ensure students read all passages of text in an assignment. A swipe lock feature may use a clock counter to regulate timing to permit page advancement. In some embodiments, the starting and stopping of the clock counter will be controlled by a determination that the user is viewing the computer display based on monitoring images or video of the user captured by the computing device, i.e. whether their attention is on the book. In some embodiments, the computer may track any combination of eye movement, head position, hand position, and body position. The determination will control the starting of the “timer” and “progress recording” of that user when their attention is on the computer display and automatically pause the timer and progress tracking if the user looks away from the display. This embodiment is especially useful in situations where the user is silently reading and the user's spoken words cannot track the reading progress. In various embodiments, the application can track a user's progress in a book based on the time spent on each page using the time recorded by the timer that “unlocks” swipe lock. A user is determined to spend an adequate amount of time on a page based on the comparison of the total number of words on a page and the mathematical product of the user's historical reading rate expressed in words per minute (wpm), and the cumulative time spent reading the page expressed in minutes. The cumulative time spent reading is determined by the timer configured to toggle on and off in response to the video recording of the user paying attention to the page being read on the computer display. In some embodiments, the timer is configured to toggle on and off in response to a changing of the virtual page by a user interface element or screen swipe. By way of non-limiting example, the user interface element may be a mouse-clickable icon. If the product is equal to or exceeds the number of words on the page, the application will consider the page to have been read. In some embodiments, instead of a historical reading rate, a user-designated, or a default reading rate may be entered and used to determine the total number of words read. This timer feature enables the application to track pages that a user might skip. For example tracking the progress of where a user is in a book. By way of non-limiting example, not only can the application determine that the user read up to page 300 of a 1000 page book (30% of the book), but a unique feature is the ability of the application to distinguish and report pages read and pages skipped by a user reading the text. In various embodiments, a user such as a teacher by selecting a graphical user interface element will enable computer instructions stored in computer memory to perform a method to determine if a page is read by a reader. FIG. 13 is a flowchart describing the steps of the method. The method 1300 will include a step 1305 of determining a value for a word count of a virtual page displayed on the computer display of a user identified by a user identifier tag (e.g. a student name), and a step 1310 of accessing from computer memory, a value for a reading rate for the user identified by a user identifier tag. The method includes a step 1315 of generating, via a timer, a value for a cumulative time spent reading the virtual page, in some embodiments based on video monitoring of the user identified by a user identifier tag viewing the computer display, and a step 1320 of generating a value for a multiplicative product of the reading rate and the cumulative time spent reading the virtual page. The method also includes a step 1325 of determining a page of text read based on the multiplicative product equal to or exceeding the word count of the virtual page. The method distinguishes the page of text read from a page of text skipped by the user identified by the user identifier tag. For example, the application may detect that the user read pages 0 to 150, skipped pages 150 to 200, and then read pages 200 to 300 based on a value for a word count for a virtual page being read, a value for a user's historical reading rate, and a value for a cumulative time spent reading the virtual page. The result may be reported in the user interface as pages read, percentage of book read, and other similar metrics. In some embodiments, the reader application can share the “read pages” metric for each user with a third party (such as a teacher or an e-learning platform) to help them distinguish the one or more pages the user read from the one or more pages the user skipped.

FIG. 14 shows a diagrammatic representation of a computing device for a machine in the exemplary electronic form of a computer system 1400, within which a set of instructions for causing the machine to perform any one or more of the methodologies discussed herein can be executed. The computer system 1400 may be implemented within the computing device 110 and the reader system 105.

In various exemplary embodiments, the computing device operates as a standalone device or can be connected (e.g., networked) to other computing devices. In a networked deployment, the computing device can operate in the capacity of a server or a client machine in a server-client network environment, or as a peer machine in a peer-to-peer (or distributed) network environment. The computing device can be a PC, a tablet PC, a set-top box, a cellular telephone, a digital camera, a portable music player (e.g., a portable hard drive audio device, such as an Moving Picture Experts Group Audio Layer 3 player), a web appliance, a network router, a switch, a bridge, or any machine capable of executing a set of instructions (sequential or otherwise) that specify actions to be taken by that machine. Further, while only a single computing device is illustrated, the term “computing device” shall also be taken to include any collection of computing devices or computers that individually or jointly execute a set (or multiple sets) of instructions to perform any one or more of the methodologies discussed herein.

The example computer system 1400 includes a processor or multiple processors 1402, a hard disk drive 1404, a main memory 1406, and a static memory 1408, which communicate with each other via a bus 1410. The computer system 1400 may also include a network interface device 1412. The hard disk drive 1404 may include a computer-readable medium 1420, which stores one or more sets of instructions 1422 embodying or used by any one or more of the methodologies or functions described herein. The instructions 1422 can also reside, completely or at least partially, within the main memory 1406 and/or within the processors 1402 during execution thereof by the computer system 1400. The main memory 1406 and the processors 1402 also constitute machine-readable media.

While the computer-readable medium 1420 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures used by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random Access Memory (RAM), Read-Only Memory (ROM), and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems.

In some embodiments, the computer system 1400 may be implemented as a cloud-based computing environment, such as a virtual machine operating within a computing cloud. In other embodiments, the computer system 1400 may itself include a cloud-based computing environment, where the functionalities of the computer system 1400 are executed in a distributed fashion. Thus, the computer system 1400, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be used exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as a client device, with each server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk, any other optical medium, any other physical medium with patterns of marks or holes, a RAM, a Programmable Read-Only Memory, an Erasable Programmable Read-Only Memory (EPROM), an Electrically Erasable Programmable Read-Only Memory, a Flash EPROM, any other memory chip or data exchange adapter, a carrier wave, or any other medium from which a computer can read.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be used in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the preceding description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A user interface for administering a reader application comprising electronic speech recognition, the user interface presented on a computer display comprising:
a user identifier tag uniquely identifying a user of the reader application;
a listing of a plurality of monitored reading performance metrics connected with the user identifier tag; and
a user-selectable list of at least one reading assistance process connected with the user identifier tag, wherein selecting an item from the list launches the respective reading assistance process comprising at least one instruction to administer the reading assistance process.

2. The user interface of claim 1, further comprising a graphical user interface element to enable a computer instruction to regulate a rate of virtual page advancement for an item of reading material displayed on the computer display.

3. The user interface of claim 1, wherein the plurality of monitored reading performance metrics comprises an identification of the item of reading material, at least one reading performance metric connected to the user identifier tag, and at least one performance goal connected to the user identifier tag.

4. The user interface of claim 3, further comprising a menu item to enable a computer instruction to set at least one performance goal for the user identified by the user identifier tag.

5. The user interface of claim 1, wherein the at least one reading assistance process comprises an instruction to provide at least one of: assistance with selection of an item of reading material, assistance with viewing a screen recording of a portion of the item of reading material, assistance with hearing an audio recording of a portion of the item of reading material read by the user, assistance with viewing incorrectly pronounced text, assistance inserting a question into a portion of the item of reading material, and assistance receiving an item of text in the form of an answer to a question relevant to the item of reading material.

6. The user interface of claim 5, further comprising a user-selectable graphical user interface element to enable insertion of the question into a portion of the reading material, the question visually appearing in response to an event comprising a turning of a virtual page of the reading material, or triggering a location marker in the reading material.

7. The user interface of claim 5, further comprising a computer instruction to enable communicating the question to the reader application on a computing device, wherein the communicating comprises at least one of text displayed on the display of the device, and audio transmitted from the device.

8. The user interface of claim 7, further comprising a computer instruction to score an answer to the question based on a statistical evaluation of a plurality of scores of answers to the question.

9. The user interface of claim 1, further comprising evaluation of a reading score based on the measured time to read a portion of an item of reading material, a measured effort required to read the portion of the reading material, and a measured difficulty of the portion of the reading material.

10. The user interface of claim 1, wherein the plurality of monitored reading performance metrics connected with the user identifier tag is determined in real-time.

11. The user interface of claim 1, wherein administering the reader application is configured to operate on a computer network.

12. The user interface of claim 1, further comprising a graphical user interface element to enable computer instructions stored in a computer memory to perform a method comprising:
determining a value for a word count of a virtual page displayed on a computer display of the user identified by the user identifier tag;
accessing from the computer memory, a value for a reading rate for the user identified by the user identifier tag;
generating a value for a cumulative time spent reading the virtual page;
generating a value for a multiplicative product of the reading rate and the cumulative time spent reading the virtual page; and
determining a page of text read based on the multiplicative product equal to or exceeding the word count of the virtual page,
wherein the method distinguishes the page of text read from a page of text skipped by the user identified by the user identifier tag.

13. The user interface of claim 12, wherein the reading rate comprises a historical reading rate, a default reading rate, or a user-specified reading rate.

14. The user interface of claim 12, wherein the cumulative time spent reading the virtual page is based on at least one from a group consisting of:
a video monitoring of the user identified by the user identifier tag viewing the computer display, and
a changing of the virtual page using a user interface element or screen swipe.

15. A user interface for a reader application comprising electronic speech recognition, the user interface presented on a computer display comprising:
a user identifier tag uniquely identifying a user of the reader application, the tag being presented in a first portion of the user interface;
a listing of a plurality of monitored reading performance metrics for the user identifier tag, the metrics being presented in a second portion of the user interface; and
a user-selectable list of at least one reading assistance process, the list being presented in a third portion of the user interface, wherein selecting an item from the list launches the respective reading assistance process.

16. The user interface of claim 15, wherein the plurality of monitored reading performance metrics comprises an identification of the item of reading material, at least one reading performance metric connected to the user identifier tag, and at least one performance goal connected to the user identifier tag.

17. The user interface of claim 15, wherein the at least one reading assistance process comprises an instruction to provide at least one of: assistance with selection of an item of reading material, assistance with viewing incorrectly pronounced text, and assistance receiving an item of text in the form of a question relevant to the item of reading material.

18. The user interface of claim 17, further comprising a user-selectable menu item to enable insertion of an answer to a question inserted into a portion of the reading material, the question visually appearing in response to an event comprising a turning of a virtual page of the reading material, or triggering a location marker in the reading material.

19. The user interface of claim 18, further comprising a computer instruction to enable communicating the answer to a computing device, wherein the communicating comprises at least one of text input into a field displayed on the device, and audio recorded on the device.

20. The user interface of claim 19, further comprising a computer instruction to view on the computing device a score to an answer to the question based on a statistical evaluation of a plurality of scores of answers to the question.

21. The user interface of claim 15, further comprising evaluation of a reading score based on the measured time to read a portion of an item of reading material, a measured effort required to read the portion of the reading material, and a measured difficulty of the portion of the reading material.

22. The user interface of claim 15, wherein the group of monitored reading performance metrics for the user is determined in real-time.

23. The user interface of claim 15, wherein the reader application is configured to operate on a computer network.

24. The user interface of claim 15, further comprising a graphical user interface element to enable computer instructions stored in a computer memory to perform a method comprising:
determining a value for a word count of a virtual page displayed on a computer display of the user identified by the user identifier tag;
accessing from the computer memory, a value for a reading rate for the user identified by the user identifier tag;
generating a value for a cumulative time spent reading the virtual page;
generating a value for a multiplicative product of the reading rate and the cumulative time spent reading the virtual page; and
determining a page of text read based on the multiplicative product equal to or exceeding the word count of the virtual page, wherein the method distinguishes the page of text read from a page of text skipped by the user identified by the user identifier tag.

25. The user interface of claim 24, wherein the reading rate comprises a historical reading rate, a default reading rate, or a user-specified reading rate.

26. The user interface of claim 24, wherein the cumulative time spent reading the virtual page is based on at least one from a group consisting of:
a video monitoring of the user identified by the user identifier tag viewing the computer display, and
a changing of the virtual page using a user interface element or screen swipe.

27. A system for administering a reader application comprising electronic speech recognition, the system comprising:
a microphone for recording an administrator's voice output;
a speaker for listening to read material from at least one user;
a memory for storing executable instructions;
a processor configured to execute the instructions, the instructions being executed by the processor to administer the reader application; and
a user interface for administering a reader application presented on a computer display, the user interface comprising:
a user identifier tag uniquely identifying a user of the reader application,
a listing of a plurality of monitored reading performance metrics connected with the user identifier tag, and
a user-selectable list of at least one reading assistance process connected with the user identifier tag, wherein selecting an item from the list launches the respective reading assistance process comprising at least one instruction to administer the reading assistance process.

28. The user interface of claim 1, further comprising a graphical user interface element representing a timer, the timer configured to access from a computer memory coupled to a processor a plurality of computer instructions that are stored in the computer memory, the computer instructions including instructions to provide the timer a value for a reading rate for the user identified by the user identifier tag for a period of time that begins when the user has begun reading and ends when the user has stopped reading.

29. The user interface of claim 28, wherein the period of time is determined by a visual monitoring of the user's reading progress as detected by a camera coupled to the computer display or based in part on the user's historical reading rate.

30. The user interface of claim 28, wherein the timer is used to determine if the user has finished reading text displayed on the computer display.
